(19) United States
(12) Patent Application Publication
(10) Pub. No.: US 2010/0309500 A1
(43) Pub. Date: Dec. 9, 2010

(54) DATA PROCESSING APPARATUS, PROGRAM, AND RECORDING MEDIUM

(76) Inventor: Katsunori SUZUKI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/793,084

(22) Filed: Jun. 3, 2010

(30) Foreign Application Priority Data
Jun. 9, 2009 (JP) 2009-137939

(51) Int. Cl. G06F 3/12

(52) U.S. Cl. 358/1.13

(57) ABSTRACT

Disclosed is a data processing apparatus including an application execution unit that transmits job data; a virtual printer driver unit that is invoked upon receiving the job data from the application execution unit, extracts job information data specifying print setting from the job data, generates a work space to perform image conversion for each job, and generates drawing data of a higher image format from the job data in the work space; and a transmission processing unit that is generated as a private instance corresponding to the job data and instructs a printer driver of a transmission destination, which is determined as the transmission destination corresponding to the job data, to print the drawing data of the higher image format under the print setting specified by the job information data so as to generate output data containing raster data compatible with a printer of the transmission destination.

### BACKGROUND OF THE INVENTION

1. Field of the Invention

The present invention relates to a print output management technology, and more specifically, to a data processing apparatus for efficiently controlling a print output destination in association with an information processing apparatus that has issued a print request. In addition, the present invention relates to a program and a recording medium used for the data processing apparatus.

2. Description of the Related Art

With an improvement in computer performance and the pervasion of network technology, a known information processing apparatus provided in an office is connected to a network and accesses the Internet, a SAS (Storage Area Network), a server, a network printer, etc., to perform various processing. The connection of an information processing apparatus to a network can provide the expansion of its access performance. On the other hand, the wide access range of an information processing apparatus may cause some problems. For example, in order to print a document file, the information processing apparatus of a company, a hospital, an inspection organization, a public office, or the like, which handles personal information and confidential information, is required to dynamically select output data in accordance with the information level of a printer.

Under such a circumstance, with an improvement in a plug-and-play technology such as Upn and Bonjour, plural accessible printers connected to a network are displayed on the printer dialog of a conventional information processing apparatus in a selectable manner at the time of instructing a print output. Therefore, when it is required to switch a print output destination for a specific output purpose, there is a likelihood of specifying a wrong output destination under a conventional printer selection method.

Furthermore, with an improvement in the print processing performance of an information processing apparatus and a printer, conversion processing into print data is accelerated. Therefore, once a print output is instructed, data other than those left in a print queue are output to a wrong output destination printer even if the cancellation of the data is attempted. Accordingly, a user who handles a document file that contains personal information and a high degree of confidentiality may cause a serious problem when specifying a wrong output destination printer. In order to solve such an inconvenience, the print dialog of a client computer (hereinafter simply referred to as a client) can be configured so as not to display all printers available on a network.

However, this method is not effective. That is, unified print output control cannot be made on a printer network that generally includes printers provided from plural different vendors and that individual settings may be required for a client.

Up until now, various output destination management of a document file has been known. For example, Patent Document 1 has proposed a technology for automatically selecting an output printer in accordance with the status of the printer such as “turned off” and “paper out.”

The system described in Patent Document 1 switches to another printer as an output destination in accordance with the status of the printer. Therefore, a print output can be performed efficiently. However, the system described in Patent Document 1 is aimed to automatically switch an output destination printer in accordance with the status of the printer but not aimed to manage an output destination that a specific information processing apparatus and a user can use.

Moreover, only with the selection of another printer in accordance with the status of the printer, a print output cannot be controlled. That is, when the printer is not in an error status even if a client issues an output request to a wrong printer, the print output is actually performed.

In addition, it may also be possible for a printer server, a terminal server, or the like to determine a user identification value or an IP address with which a print instruction has been issued, or contents of print data so as to collectively manage print output destinations. However, a printer driver is generally managed by an operating system (OS). Therefore, when the printer driver is exclusively used by one print job, the printer driver cannot start the processing of a subsequent print job, which in turn causes the bottle neck of a throughput.

After the printer driver completes image processing and output data are output to a specified printer, the printer driver starts the processing of the subsequent print job.

Therefore, if a print error about output data that have been transmitted is caused by the specified printer, a data processing apparatus such as a printer server and a terminal server is required to have an error notification management module separated from the printer driver so as to perform error notification.

In other words, the conventional system makes it possible to select an output destination printer in accordance with the status of a printer and allows a user to specify which printer data are output prior to printing. However, if the user issues a print instruction specifying a wrong output destination, a document file is output to an unintended output destination printer, which results in the leakage of personal information and confidential information. Moreover, under the conventional system, even if a wrong output destination printer is selected, the output destination printer is specified in association with a user who accesses an information processing apparatus, and data are reliably output to an output destination printer set for the information processing apparatus and the user. Therefore, the leakage of information on a document file having a high degree of confidentiality must be prevented.

Furthermore, a technology is demanded which manages a print output destination and performs a print output under high security while dealing with so many clients and printing a large amount of full-color images. In addition, even if printers provided from plural vendors exist together, print output control must be efficiently made not only for a fat client but also for a thin client without greatly modifying or integrating a program.

Patent Document 1: JP-A-2003-140867

### SUMMARY OF THE INVENTION

The present invention has been made in light of the above problems of the conventional technology and may provide an information processing apparatus that allows a user to output data to an output destination set as an output destination printer in association with the information processing apparatus or a user who accesses the information processing apparatus regardless of printer output settings of the information processing apparatus. The present invention may also provide a print output control method, a program, and a recording medium used for the information processing apparatus. Moreover, the present invention may provide an information processing apparatus capable of controlling an output destination printer regardless of whether vendors are the same or different under a circumstance where printers provided from the vendors exist together. The present invention may also provide a program and a recording medium used for the information processing apparatus.

According to an aspect of the present invention, there is provided a data processing apparatus that receives and prints job data. The apparatus includes an application execution unit that transmits the job data to the data processing apparatus; a virtual printer driver unit that is invoked upon receiving the job data from the application execution unit, extracts job information data specifying print setting from the job data, generates a work space to perform image conversion for each job, and generates drawing data of a higher image format from the job data in the work space; and a transmission processing unit that is generated as a private instance corresponding to the job data and instructs a printer driver of a transmission destination, which is determined as the transmission destination corresponding to the job data, to print the drawing data of the higher image format under the print setting specified by the job information data so as to generate output data containing raster data compatible with a printer of the transmission destination.

Other objects, features and advantages of the present invention will become more apparent from the following detailed description when read in conjunction with the accompanying drawings.

### BRIEF DESCRIPTION OF THE DRAWINGS

FIG. 1 shows an embodiment of a printer network 100 including a data processing apparatus 110 according to the present invention;

FIG. 2 is a function block 200 of the data processing apparatus 110 of this embodiment;

FIG. 3 is a flowchart of processing executed by the data processing apparatus 110 of this embodiment;

FIG. 4 shows the corresponding table 400 managed by a transmission destination control unit 242 in this embodiment;

FIG. 5 shows a transmission management table 500 used in this embodiment;

FIG. 6 is a flowchart in which the data processing apparatus 110 monitors a printer status in this embodiment; and

FIG. 7 shows a status transition 700 of a data processing unit 210 in this embodiment.

### DETAILED DESCRIPTION OF THE PREFERRED EMBODIMENTS

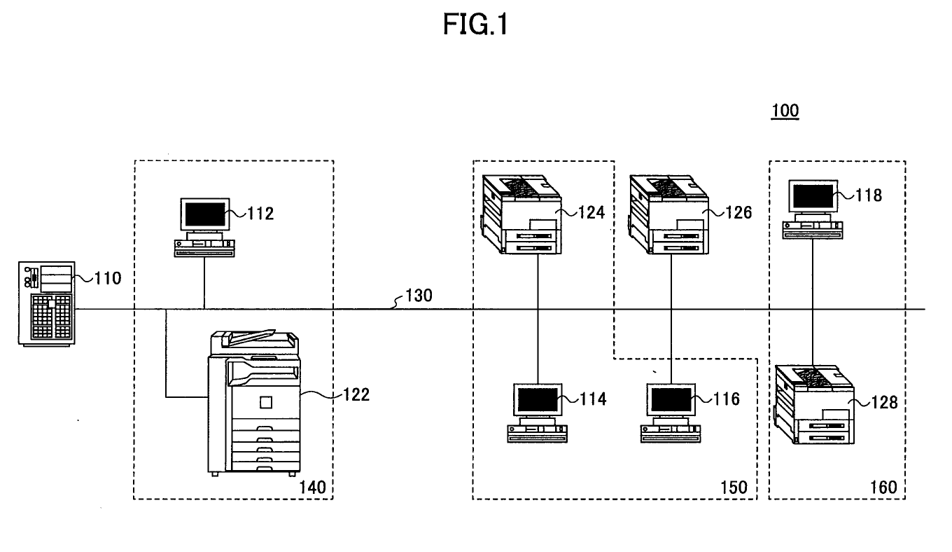

Next, the present invention is explained with reference to an embodiment but not limited to it. FIG. 1 shows the embodiment of a printer network 100 including a data processing apparatus 110 according to the present invention. The printer network 100 is configured in such a manner that plural clients 112, 114, 116, and 118 provided in an office or the like are connected to a network 130. The network 130 is connected to a printer server (not shown), besides the data processing apparatus 110. The printer server may manage a print request from each of the clients 112, 114, 116, and 118.

In the exemplified embodiment shown in FIG. 1, a MFP (Multi-Function Peripheral) 122, laser printers 124 and 126, an ink jet printer 128, and the like are connected to the network 130 as remote printers. In this embodiment, the MFP 122 and the page printers 124, 126, and 128 are collectively referred to as the remote printers.

In the embodiment shown in FIG. 1, the data processing apparatus 110 acquires a print request from each of the clients 112, 114, 116, and 118 and print data corresponding to the print request, determines the remote printer allocated to each of the clients 112, 114, 116, and 118, and activates a remote driver 250 corresponding to the remote printer. Then, a data processing unit 210 transmits RAW data corresponding to the print data to the remote printer allocated to the client involved. Note that the generated RAW data are converted into output data after being subjected to processing for adding, for example, a PDL (Page Description Language) command, and transmitted to the designated one of remote printers 122, 124, 126, and 128. The remote printers 122, 124, 126, and 128 correspond to the client 112, 114, 116, and 118, respectively, and execute print processing at locations where the remote printers are provided.

Note that in this embodiment, when the remote printers are allocated to the clients 112, 114, 116, and 118, identification values related to the hardware of the clients such as IP addresses, MAC addresses (Media Access Control Addresses), computer names added to the clients, or the login names of users can be used. In this embodiment, these values are collectively referred to as output request source identification values. Further, in the preferred embodiment of the present invention, the clients 112, 114, and 116 have an IC card reader for identifying the user of the clients 112, 114, and 116 and allowing each user to print with the allocated remote printer.

In the preferred embodiment, the data processing apparatus 110 is mounted as a server apparatus, includes a single core or a multi-core CPU, a ROM, a RAM that provides an actual space, and a hard disk device, and the like, and controls the output destination of print data under an operating system such as Windows™ 200X server, UNIX™, or Solaris™. Further, the data processing apparatus 110 can make a transaction with the clients 112, 114, 116, and 118 by using an adequate remote connection protocol such as a RDP. Further, when the client 112 is mounted as a fat client, the function of the data processing apparatus 110 can also be mounted as the function of the client.

The remote printers 122, 124, 126, and 128 can be allocated to the clients 112, 114, 116, and 118 in various ways. For example, in a specific embodiment, a remote printer can be allocated to an output destination for each output request source identification value with which a client or a user is inherently identified. Further, in another embodiment, a client group or a user group is specified, and a specific remote printer can be allocated in units of such a group. In the embodiment shown in FIG. 1, the client 112 and the remote printer 122 constitute the location 140. In this manner, the clients and the printers correspond to each other to constitute the locations 150 and 160. Plural clients can exist at the locations 140, 150, and 160, and plural remote printers can exist at the locations.

In this embodiment, when the printer server is connected to the printer network 100, the printer server can receive a print request from each of the clients 112, 114, 116, and 118 and transmit print data to each of the remote printers 122, 124, 126, and 128 allocated to the clients 112, 114, 116, and 118 to execute a print job. The printer server may have the same configuration as that of the data processing apparatus 110 in terms of a hardware configuration and an OS configuration. Note that the printer server is not necessarily mounted on the server apparatus. Instead, it can be so configured that a personal computer has a printer server application installed therein.

The clients 112, 114, 116, and 118 have the same configuration, and can be configured of a fat client apparatus, for example, a personal computer or a work station that has an application program installed therein and completes various processing. When the clients 112, 114, 116, and 118 are mounted as the fat clients, the clients 112, 114, 116, and 118 have a single core or a multi-core CPU mounted thereon, include a RAM, a ROM, a hard disk device, a network interface card (NIC), and request the remote printers 122, 124, 126, and 128 to perform print processing under an adequate OS such as Windows™, UNIX™, LINUX™, and MAC OS™.

The clients 112, 114, 116, and 118 mounted as the fat clients read an application program and data from the hard disk device or the like into the RAM and cause the CPU to execute the application program, thereby generating a document file to be printed as a document, an image, a multi-media, or electronic data obtained by combining the document, the image, and the multi-media with each other.

Further, in another embodiment, the clients 112, 114, 116, and 118 can be mounted as so-called thin clients. The thin clients have mounted thereon only the function of issuing a service request exclusively to the data processing apparatus 110, receiving a processing result, and requesting a print output, such as a network connection module, a user authentication function, and a session generation module. When the clients 112, 114, 116, and 118 are mounted as the thin clients, the clients 112, 114, 116, and 118 complete processing with an application and then issue a print request to the data processing apparatus 110.

The data processing apparatus 110 makes it possible to give data generated in response to the request by each of the thin clients to a virtual printer driver, and perform the management of an output destination, a status, and image conversion processing for each job. The generated output data are transmitted to each of the remote printers corresponding to the clients 112, 114, 116, and 118 and subjected to print processing. Note that the virtual printer driver is more specifically described. In this embodiment, when many print requests are issued from a multiplicity of the clients, the virtual printer driver of the data processing apparatus 110 makes it possible to perform the parallel processing of the print requests in units of jobs, thereby improving efficiency in status management as well as print efficiency. Moreover, in this embodiment, the virtual printer driver makes it possible to perform processing efficiently even if the print request is described in a higher format accompanying drawing information such as EMF (Enhanced Metafile), PDF, and XPS, besides lower image data such as a bit map.

The network 130 can be configured of Ethernet™ such as 1000 Base-TX, an optical network, and a wireless network such as IEEE802.11 format, and perform mutual communications with a packet communication based on a TCP/IP protocol. Further, the network 130 may be configured of a wide-area network such as the Internet constructed under a secure environment by a VPN (Virtual Private Network) or the like, besides a LAN.

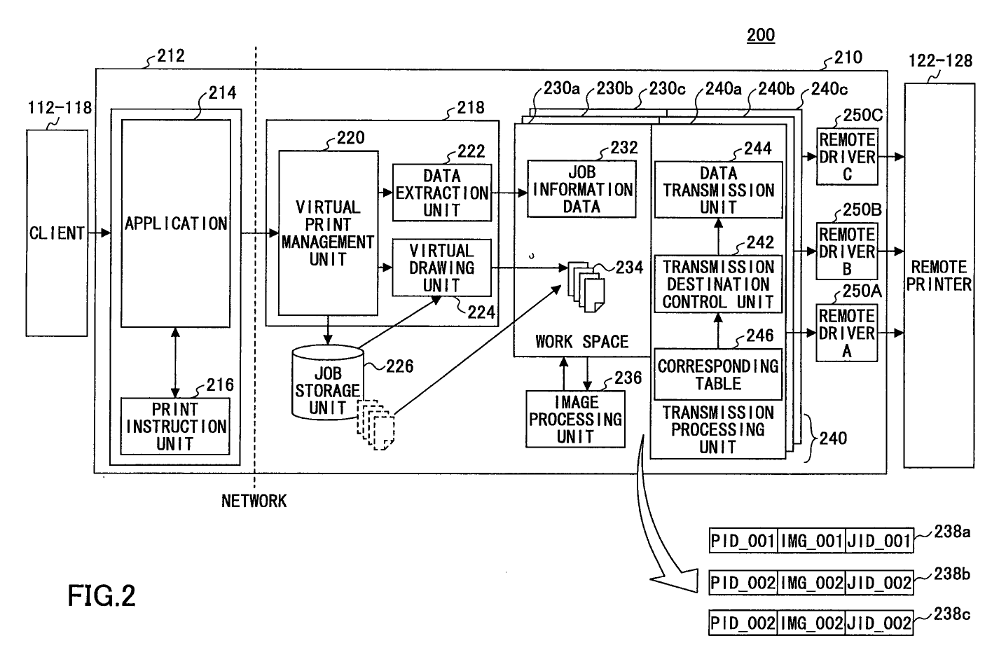

FIG. 2 is a function block 200 of the data processing apparatus 110 of this embodiment. As shown in FIG. 2, the data processing apparatus 110 includes plural function units. These function units are implemented on a computer when a program read into the the RAM or the like is executed by the CPU.

As shown in FIG. 2, the data processing apparatus 110 includes a data processing unit 210 and an application execution unit 212. The data processing unit 210 and the application execution unit 212 of the data processing apparatus 110 can be integrated with each other as shown in FIG. 2. Further, in a specific embodiment, defining dotted lines shown in FIG. 2 as a network boundary, a function unit on a left side can be mounted as a terminal server and that on a right side can be mounted as the data processing apparatus 110. The application execution unit 212 receives a processing request and a print request from each of the clients 112, 114, 116, and 118 through the network 130, and executes processing to generate an execution result. The execution result is converted into a print job (hereinafter simply referred to as a job) after being subjected to an API call such as a GDI in response to a print instruction event by a print instruction unit 216. Then, the data of the job are transmitted to the data processing unit 210.

In another embodiment, the function module is not necessarily mounted as in FIG. 2. For example, the clients 112, 114, 116, and 118 can have the functions of the application execution unit 212 and the data processing unit 210, or they can have the application execution unit 212 mounted thereon. In other words, the clients 112, 114, 116, and 118 can be mounted as so-called fat clients. In still another embodiment, the terminal server that processes a request from a thin client can have the functions of the application execution unit 212 and the data processing unit 210. Moreover, in yet another embodiment, the clients 112, 114, 116, and 118 can be thin clients, the terminal server has the application execution unit 211 mounted thereon, and the data processing unit 210 can be mounted as a printer server. These specific embodiments can be appropriately changed in accordance with an environment where the printer network 100 is provided and a specific purpose of a user.

The data processing unit 210 includes a virtual printer driver 218, a job storage unit 226, and a transmission processing unit 240. The job storage unit 226 temporarily stores image data and job information data from job data transmitted from an application 214 at a time when the virtual printer driver 218 is invoked. The transmission processing unit 240 transmits data to be output and printed to a remote driver while controlling the transmission destination of the remote printer as an output destination. The virtual printer driver 218 is activated when being invoked by the print instruction unit 216 mounted as the print instruction module of the application execution unit 212, and starts its processing after receiving job data transmitted from the application 214.

In this embodiment, job data include image data and job information data. The image data can contain lower image data such as bit map, JPEG, and GIF or higher image data such as EMF including a drawing code, Post Script™, and PDF. In another embodiment, the image data can contain both the higher image data and the lower image data. Further, the job information data are associated with print settings such as identification values with which the issuance source of a print request is inherently identified, imposing information of image data, margins, and sizes.

In this described embodiment, upon receiving a print request from each of the clients 112, 114, 116, and 118, the print instruction unit 216 generates a process ID with which a currently started job is inherently identified. Then, the print instruction unit 216 transmits the process ID to notify that the new job has been started. After receiving the process ID, the virtual printer driver 218 generates private instances 240a through 240c of the transmission processing unit 240 for the job involved, and causes each of the private instances to execute processing determining a transmission destination. The private instances 240a through 240c activated for each job acquire image data from work spaces 230a through 230c and execute imposing with the image processing unit 236 and allocation of print settings.

Meanwhile, the corresponding transmission processing unit, for example, the private instance 240a refers to a user name, an IP address, or the like contained in the job information data and determines the remote printer as an output destination based on a corresponding table. The corresponding table is a table in which user names, values of IP addresses or the like of clients, and allocation of the remote printers as output destinations are registered, and can be managed by a transmission destination control unit 242. When the transmission destination control unit 242 determines the remote printer as the transmission destination, the data transmission unit 244 acquires data of a higher image format generated in the work space 230a and transmits the same to the determined remote driver 250A.

Further, if the remote driver 250A determined as the transmission destination has a page assignment function and an imposing function, the image processing unit 236 converts the format of image data 234 generated as a higher image format into one capable of being received by the remote driver 250A and causes the remote driver 250A to convert the job information data 232 with the job information data 232 specified as a function setting value of the remote driver 250A, thereby making it possible to generate RAW data. For example, in a specific embodiment, most printer drivers of Windows™ can receive EMF. Therefore, if the image data 234 are in the form of EMF, they are not required to be converted. Instead, if the job information data 232 are set in a print setting structure DEVMODE, the remote printer driver 250A can generate desired RAW data. If the remote driver 250A does not have the page assignment function and the imposing function, EMF is divided into pieces to correspond to pages, the order of the pages is changed, and a drawing position is specified, thereby making it possible to obtain desired RAW data.

Note that the private instances 240a through 240c not only manage the remote driver 250A shown in FIG. 2 but also invoke a remote driver as the transmission destination determined by the transmission destination control unit 242. In this embodiment, the job processing functions of the data processing unit 210 are divided into the virtual printer driver 218 and the transmission processing unit 240. The private instances of the transmission processing unit 240 are generated as the private instances 240a through 240c. In this manner, transmission processing to the remote printer as the transmission destination is performed for each job. Accordingly, a print stoppage when an error is caused in the remote printer can be minimized.

As a result, the transmission processing unit 240 can acquire a separate spool space for each job. Further, even if an error is caused in a specific remote printer and an error job cannot be eliminated from a printer queue, the transmission processing unit 240 can limit a trouble caused by the error only to the job of the remote printer that has caused the error without affecting a previous job processed by the virtual printer driver 218. Note that if the data processing apparatus 110 can receive an input from a user to control processing, the print instruction unit 216 can receive a mouse event or the like and issue a print instruction.

When image data are color image data and configured of lower image data such as bit map, spool processing of the image data requires time and exclusive processing is generally performed in which a next print request is not accepted unless the spool processing is completed. Therefore, particularly when the data processing apparatus 110 processes a color image of lower image data, it causes a bottle neck with image conversion processing. Therefore, in this embodiment, the format of job data containing a color image is converted into a higher image format including as many drawing codes as possible, thereby reducing an image data amount and allocating a separate work space to each job so as to shift color image data to the operations spaces 230a through 230c. Thus, output data of a RAW format capable of being output from the remote printer as the transmission destination can be efficiently generated.

Here, the configuration of the virtual printer driver 218 is more specifically described. The virtual printer driver 218 includes a virtual print management unit 220, a data extraction unit 222, and a virtual drawing unit 224. Upon receiving job data, the virtual printer driver 218 invokes the virtual print management unit 220 and stores the job data in the job storage unit 226. On the other hand, the virtual print management unit 220 invokes the virtual drawing unit 224 to secure as the work spaces 230a through 230c storage spaces where image data out of the job data stored in the job storage unit 226 are processed so as to correspond to a job. The work spaces 230a through 230c are formed in such a manner that an appropriate capacity of a storage space such as the RAM managed by the data processing unit 210 is used. In this embodiment, the work spaces 230a through 230c can be referred to as, for example, virtual spoolers. The data extraction unit 222 extracts job information data 232 from the job data temporarily stored in the job storage unit 226 and gives the same to the corresponding transmission destination control unit 242 among the private instances 240a through 240c of the transmission processing unit 240.

Hereinafter, the job data being processed are handled in the work space 230a. The virtual drawing unit 224 moves the image data stored in the job storage unit 226 from the job storage unit 226 to the work space 230a and generates drawing data of a higher image format inside the work space 230a. For example, in the case of a Windows™ system as a specific embodiment, a printer processor can copy an EMF file generated by a Spooler to the work space, and a graphic module can generate an EMF. Referring to the job information data 232, the drawing data are generated in a format in which page assignment and margin settings are performed. The job storage unit 226 is emptied, and the completion of image processing is notified to the application execution unit 212. At this stage, the application 214 withdraws exclusive management for the job storage unit 226 and is allowed to execute the processing of a subsequent print request. Note that various methods such as Semaphore and Synchronization Class can be used as the exclusive management. In another embodiment, exclusive control can be easily made in such a manner that a GUI (Graphical User Interface) providing the pint instruction unit 216 of the application execution unit 212 is displayed so as not to receive an event.

The job storage unit 226 can be mounted as a storage area where a printer buffer or a spool file is stored in accordance with the embodiment of the data processing unit 210, and is not limited to the mounting format of a specific OS. For example, the image data moved into the work space 230a are transmitted to the image processing unit 236 of the data processing unit 210. The image processing unit 236 acquires the image data and the job information data 232 from the work space 230a generated for each job and executes processing such as page assignment and imposition. The private instance 240a invokes the remote driver 250A as a transmission destination determined at that point and converts the format of the received data into a RAW format inherent in each of the remote printers 122, 124, 126, and 128 by using imposition and print setting values, and transmits the output data of the RAW format to, for example, the printer 122.

In this embodiment, the image processing unit 236 can be mounted as an image processing module such as a drawing module including the remote driver 250 and a drawing processor. More specifically, the image processing unit 236 invokes the drawing processor to execute the processing in the case of a higher image format including a drawing control code, such as EMF, PDF, and PostScript™ and a vector image. Further, if image data to be processed are lower image data such as BMP, the image processing unit 236 can generate the output data of the RAW format by invoking the remote driver 250 to execute image conversion and repeating the processing with the work space 230a until the generation of a raster image is completed by the remote driver 250. Moreover, the private instance 240a links the job information data 232 extracted by the data extraction unit 222 to process IDs and images to generate job management lists 238a through 238c, which can be used for managing correspondence between the private instances.

In this embodiment, image data may contain lower image data that do not contain drawing codes such as bit map, JPEG, JPEG 2000, PNG, and GIF. In this embodiment, even if image data contain the lower image data, the work spaces 230a through 230c are generated and the processing is repeated using the work spaces 230a through 230c until the generation of RAW data is completed by the invoked remote driver 250. Note that if job information has both the lower image data and the higher image data, the drawing processor and the remote drivers 250A through 250C are invoked as required to execute the processing. With the above configuration, the transmission processing unit 240 can provide excellent outputs of the remote printers 122, 124, 126, and 128 while securing consistency between data for each job.

Moreover, the configuration of the transmission processing unit 240 is described exemplifying the private instance 240a. Note that the private instances 240b and 240c have the same configuration as that of the private instance 240a. The private instance 240a includes the transmission destination control unit 242 and the data transmission unit 244. Referring to the corresponding table 246, the transmission destination control unit 242 acquires the transmission destination of output data from the job information data 232 separated and extracted from the job data by the data extraction unit 222 in association with the issuance source of a print request. Then, the transmission destination control unit 242 notifies the data transmission unit 244 of the acquired transmission destination. The data transmission unit 244 invokes the remote driver 250A or the like as the transmission destination of the output data in response to the notification from the transmission destination control unit 242.

Upon receiving the notification on the transmission destination, the data transmission unit 244 sets the transmission destination in the record of the corresponding job ID of a transmission management list for each process ID. Further, upon receiving output data from the work space 230a, the data transmission unit 244 transmits the output data to a port monitor or the like, thereby making it possible to print and output the output data from each of the remote printers 122, 124, 126, and 128. Note that a specific embodiment of the transmission management list is described below.

In this embodiment, it is preferable to transmit a job in a format including higher image data as possible to the virtual printer driver 218. This is because when the image data as the higher image data are transmitted, it becomes possible to reduce a data amount per image particularly on a color image and eventually make the data processing unit 210 deal with more print requests.

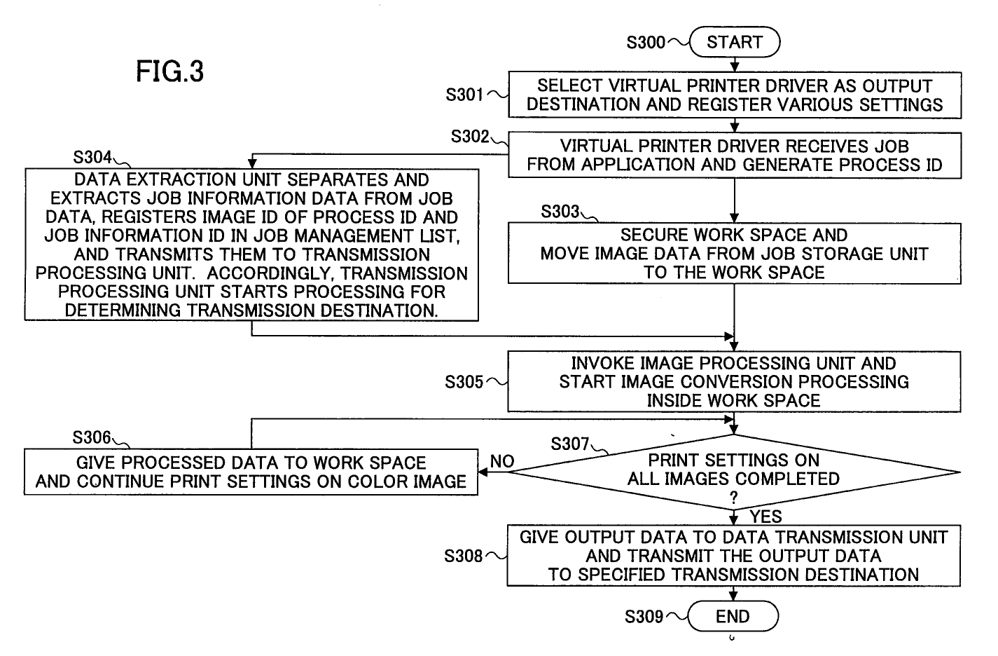

FIG. 3 is a flowchart of the processing executed by the data processing apparatus 110 of this embodiment. The processing shown in FIG. 3 starts from step S300. In step S301, the virtual printer driver 218 is selected, and various settings are registered. Note that the manager or the like of the data processing apparatus 110 can perform this registration with a dedicated GUI. In the case of the embodiment shown in FIG. 2, the application 214 generates an execution result in response to a request from each of the clients 112, 114, 116, and 118 and gives the generated execution result to the virtual printer driver 218. In step S302, the virtual printer driver 218 receives a job from the application 214 and generates a process ID (PID), and registers the generated process ID in the field of the job management lists 238a through 238c.

Afterwards, in step S304, the data extraction unit 222 separates the job information data 232 from job data, registers a job information ID (JID) in the job management list 238a, and transmits the registered job information ID to, for example, the private instance 240a associated with the job. At the same time, the data extraction unit 222 allocates an image ID (IMGID) to the separated image data and transmits the same to the job storage unit 226. Further, in parallel with the image conversion processing by the image processing unit 236, the private instance 240a starts processing for determining a transmission destination.

In step S303, the work space 230a is generated, and the image data are moved from the job storage unit 226 to the work space 230a. In step S305, the image processing unit 236 is invoked to start the image conversion processing. In step S305, the image data are moved from the job storage unit 226 to the work space 230a. If the image data refer to a color image not in a higher image format, the image processing unit 236 executes a higher image format. Further, in step S305, the image processing unit 236 executes the image conversion processing by using the job information data 232. Note that the image conversion includes processing such as image imposing and allocation of print sizes and margins.

In step S307, it is determined as to whether the image processing by the image processing unit 236 has been completed. If the image processing has not been completed (no), the image data are acquired from the work space 230a in step S306 and the processing is repeated in the work space 230a until the image conversion and the format settings with respect to all the images being processed are completed. After the image conversion processing has been completed with respect to all the image data (yes), output data are transmitted to the data transmission unit 244. By looking up the transmission management table and invoking the remote driver 250A corresponding to a transmission destination allocated to the process ID, the data transmission unit 244 generates the output data. Then, the data transmission unit 244 transmits the generated output data to the remote printer 250A as a target through, for example, a port monitor. Note that before transmitting the output data to the data transmission unit 244, the remote driver 250A can add a PDL (Page Description Language to) to the image-converted output data to transmit the output data to the targeted remote printer.

In this embodiment, the image processing unit 236 has the function of generating images of job data of a higher image format, and the remote driver 250 is automatically acquired by a plug-and-play function such as UPnP and Bonjour. Accordingly, a page printer is not limited to one by a specific manufacturer of a specific mounting format, but it is possible to perform the processing with a page printer which is only connected to the printer network 100 and allowed to use a plug-and-play function, namely an automatic driver transfer protocol.

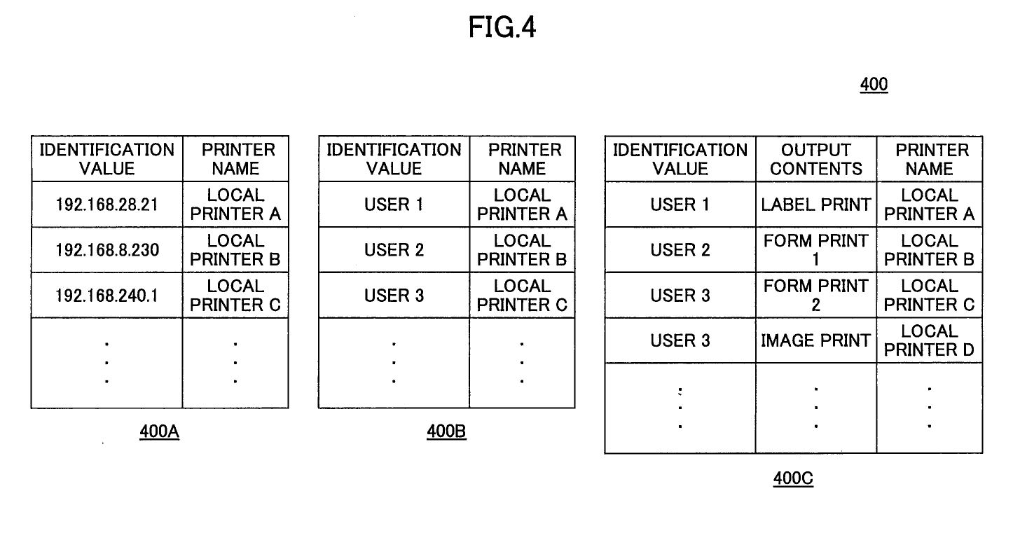

FIG. 4 shows the corresponding table 400 managed by the transmission destination control unit 242 in this embodiment. In a corresponding table 400A, IP addresses or user names and names of local printers allocated to the user names are registered in association with each other using the IP addresses input by clients and the user names read from IC cards as identification values for identifying an output request source from each of the clients 112, 114, 116, and 118. The local printers are identified as the remote printers with respect to the data processing unit 210, and allocated with values for inherently identifying the printers provided in the locations 140 through 160. Further, the IP addresses are not limited to the single values as shown in the corresponding table 400A, but can be in the range specified by a subnet mask or the like so as to correspond to a specific group.

In a corresponding table 400B, the user names as the identification values of output request sources and the printer names for inherently identifying the remote printers including the local printer A and the like are registered in association with each other. Note that in the embodiment in which the output destinations are managed in association with the user names, an output destination printer can be specified corresponding to a user regardless of which client the user accesses. In this case, since the user can reliably transmit a change in printer settings to the output destination without inputting it to the client even if the terminal is changed, it is possible to improve efficiency in operability and ensuring the security of a document. With the corresponding table 400 shown in FIG. 4, a manager of the data processing apparatus 110 can perform an input by using an appropriate database.

Further, in this embodiment, it is also possible that clients, user names, or the like to which specific IP addresses are allocated are linked to each other. That is, when the same user uses a different client, he/she may perform an output to a different output destination printer.

In a corresponding table 400C, output contents are combined with the identification values of the users so that output destinations are linked to each other. In the corresponding table 400C, plural network printers as local printers C and D are allocated to the user 3.

A printer function is different, for example, between form print, label print, and color print. Further, even with the form print, a format and an output function are different. Therefore, the output contents are used for controlling the output destinations based on these differences. Note that the output contents may be given as the job information data 232 from the application, or the data processing apparatus 110 may determine them by using the metadata of the job information data. Further, when plural remote printers are allocated to a specific identification value, it is possible to select a printer name registered at an upper level as a default. That is, it is possible to select the remote printer only in an interactively specified range by inquiring the clients 112, 114, 116, and 118.

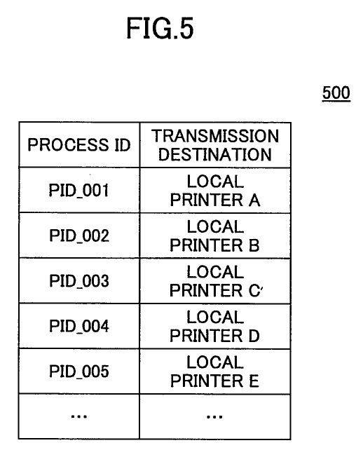

FIG. 5 shows a transmission management table 500 used in this embodiment. In the transmission management table 500, the process IDs and the transmission destinations are registered in association with each other. In this embodiment, the transmission management table 500 can be collectively managed by the data transmission unit 244, and appropriately managed, generated, and updated by any module so as to correspond to a specific purpose and a mounting format. In the transmission management table 500, the process ID, which is generated as a value inherent in a job when the application 214 makes a request of the job to the virtual printer driver 218, is registered as, for example, PID_{—}001.

The private instances 240a through 240c look up the corresponding table 400 by using the received job information data 232 to determine a transmission destination and registers the determined transmission destination in a transmission destination field in which the corresponding process ID of the transmission management table 500 is registered. As the transmission destination, a printer name or an IP address may be used.

The data transmission unit 244 acquires a value of the transmission destination by referring to the process ID of a job to be processed and invokes a corresponding remote printer driver as a module with the acquired value of the transmission destination as an argument. Then, the data transmission unit 244 starts generating output data of a RAW format. Next, after appropriately executing the processing for adding, for example, a PDL, the data transmission unit 244 makes it possible to transmit the data to a dispatch processing unit such as a port monitor and perform an output from the remote MFP 122, and any of the page printers 124, 126, and 128 through the network 130.

Note that if the data processing unit 210 does not have the printer driver corresponding to the transmission destination, the remote drivers 250a through 250c are acquired by a protocol such as UPnP so that the data transmission unit 244 can be used. If the data processing apparatus 110 supports UPnP by default, it usually has a remote driver for a remote printer available.

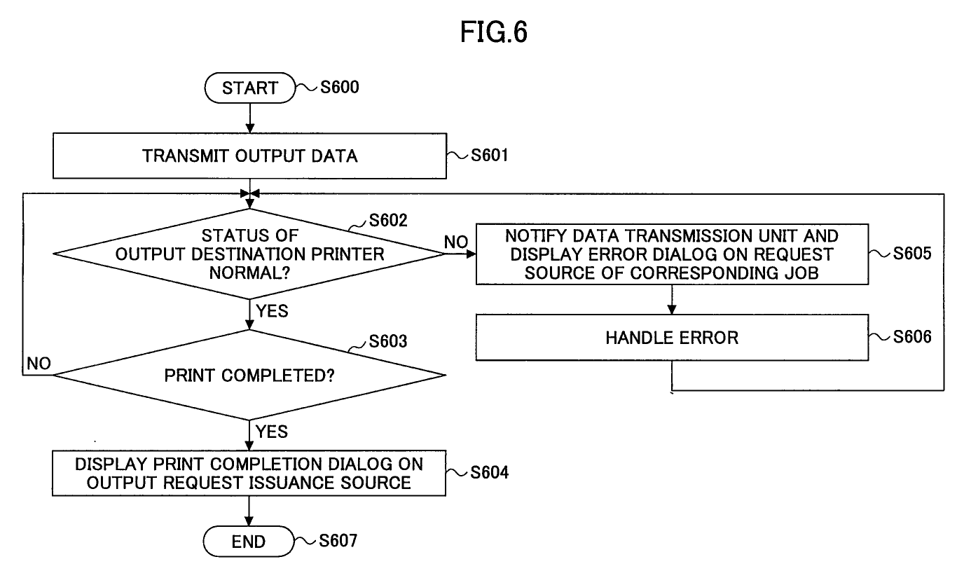

FIG. 6 is a flowchart in which the data processing apparatus 110 monitors a printer status in this embodiment. The virtual printer driver 218 exists during a period in which the work space 230a for a process ID managed by the virtual printer driver 218 exists, and manages the generation of the processing in the work space 230a, the deletion of resource allocation on a hardware resource, or the like. At the same time, by using a SNMP protocol, the virtual printer driver 218 monitors the status information of a remote printer corresponding to the process ID managed by the virtual printer driver 218. The processing shown in FIG. 6 starts from step S600. In step S601, RAW data are generated, and a PDL command is added to the RAW data. Then, output data containing the RAW data are transmitted to an output destination printer. In step S602, it is determined as to whether the status of the output destination printer is normal. If the status is determined to be normal in step S602 (yes), it is then determined in step S603 as to whether a print completion notification has been received from the output destination printer.

If printing has not been completed (no), the processing returns to step S602 so that the status of the output destination printer is continuously checked until the print completion notification is received. Note that the processing of the data processing apparatus 110 can be directly checked in such a manner that the data processing apparatus 110 serves as a SNMP master and the output destination printer serves as a SNMP slave. When detecting a change in the status, the data processing apparatus uses a SNMPtrap command. Further, the data processing apparatus 110 acquires the status when the output destination printer releases it to the public by using a MIB.

On the other hand, if the status of the output destination printer is determined to be abnormal in step S602 (no), the data processing apparatus 110 specifies which of the clients 112, 114, 116, and 118 causes an error by referring to the transmission management table 500, the job management lists 238a through 238c, and the corresponding table 400, and causes the client involved to display an error dialog. In order to display the error dialog, the data processing apparatus 110 invokes the print instruction unit 216 as the status abnormality of the virtual printer driver 218 and causes the specified one of the clients 112, 114, 116, and 118 to display the printer status dialog.

Therefore, the data processing unit 210 activates a SNMP manager service. Upon receiving a trap command, the data processing unit 210 checks the MIB released to the public by the remote printer, displays the error dialog on the desktop screen of the corresponding one of the clients 112, 114, 116, and 118 or the data processing apparatus 110, and causes a text or the like for displaying a method for handling the error to be displayed on the error dialog in step S606. Afterwards, the processing returns to step S602 where the remaining data of a document file are held until the status of the printer causing the error becomes normal to secure the completion of processing.

When the status of the output destination printer becomes normal, data to be printed are processed in step S603, and the data processing apparatus 110 receives the print completion notification, the print completion dialog is displayed on the desktop screen of the client in step S604 and the checking of the status is completed in step S607.

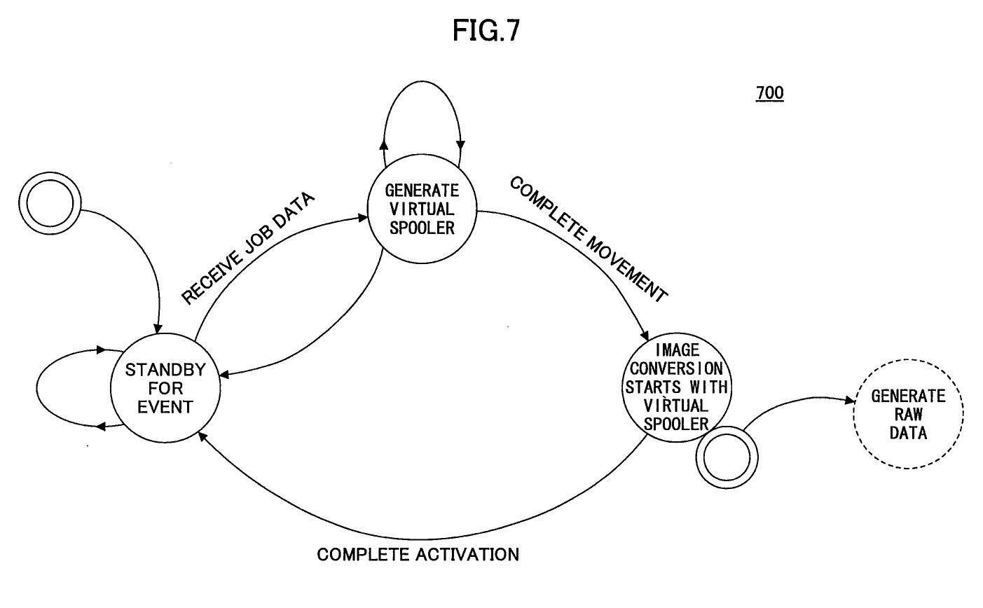

FIG. 7 shows a status transition 700 of the data processing unit 210 in this embodiment. When being activated, the data processing unit 210 transits to an event standby status for receiving a job from the application 214. After receiving the job, the data processing unit 210 invokes the virtual drawing unit 224 and generates the work spaces 230a through 230c, which are associated with a process ID and referred to as a virtual spooler, for each job in the embodiment described. Then, the data of the job storage unit 226 are generated inside the generated work space 230a so as to store the drawing data of a higher format, and the image conversion processing using the virtual spooler is started when the generation of the moving and drawing data is completed. When the moving of the image data to the work spaces 230a through 230c is completed, the data processing unit 210 transits to the event standby status for dealing with a new job.

On the other hand, the image data moved to the virtual spooler are subjected to print settings by the image processing unit 236, invoke any of the remote drivers A through C determined as a transmission destinations, and are transmitted to processing for generating output data (RAW data). In the processing for generating the output data as indicated by dotted lines in FIG. 7, any of the remote drivers 250A through 250C corresponding to the transmission destinations is invoked, and processing for generating the output data as the RAW data based on the data transmitted from the data transmission unit 244 is executed. After the data transmission unit 244 activates the processing for generating the output data and transmits data to be processed, the data processing unit 210 transits to the event standby status to be on standby for a next job.

As shown in FIG. 7, the data processing apparatus 110 of this embodiment can move the data from the job storage unit 226 to the work spaces 230a through 230c at high speed without the processing for drawing higher image data, withdraw the exclusive management of the image processing unit 236 by the application 214 when the moving of the data is completed so as to create a standby status for the next print instruction event by the application execution unit 212. Accordingly, the control of the application execution unit 212 can be restored immediately. As a result, it is possible to transit to the event standby status immediately after the generation of the work spaces 230a through 230c. Therefore, a higher capacity for processing a job can be provided while assuring the security of printing a document.

As described above, according to the embodiment of the present invention, it is possible to provide a data processing apparatus capable of performing an output with the same printer at any time by using user information and client information from a client connected through a network and capable of improving efficiency in management for each output operation and information security under a present network print environment in which a personal computer and a thin client are allowed to access plural image forming apparatuses. Further, it is possible to provide a program and a storage medium used for the data processing apparatus. In addition, according to the embodiment of the present invention, it is possible to provide a data processing apparatus capable of efficiently dealing with color image print requests from a multiplicity of clients by processing a color image as higher image data containing a drawing code and capable of controlling an output destination while making it possible to perform a print output at higher speed and with larger capacity. Further, it is possible to provide a program and a recording medium used for the data processing apparatus.

Moreover, according to the embodiment of the present invention, it is possible to provide a data processing apparatus capable of managing an output destination of a print output while corresponding to a more flexible network configuration in such a manner that the additional mounting of the printer driver of a remote printer to a thin client is eliminated. Further, it is possible to provide a printer network system, a data processing method, a program, and a storage medium used for the data processing apparatus.

The above function of this embodiment can be implemented by an apparatus-executable program described in an object-oriented programming language such as C, C++, C#, and Java™. Further, the program of this embodiment can be distributed in a state of being stored in an apparatus-readable recording medium such as a CD-ROM, a MO, a DVD, a flexible disk, an EEPROM, and an EPROM, and can be transmitted through a network in a format capable of being executed by other apparatuses.

The present invention is not limited to the specifically disclosed embodiments, and variations and modifications may be made without departing from the scope of the present invention.

The present application is based on Japanese Priority Application No. 2009-137939 filed on Jun. 9, 2009, the entire contents of which are hereby incorporated herein by reference.

What is claimed is:

1. A data processing apparatus that receives and prints job data, the apparatus comprising:
an application execution unit that transmits the job data to the data processing apparatus;
a virtual printer driver unit that is invoked upon receiving the job data from the application execution unit, extracts job information data specifying print setting from the job data, generates a work space to perform image conversion for each job, and generates drawing data of a higher image format from the job data in the work space; and
a transmission processing unit that is generated as a private instance corresponding to the job data and instructs a printer driver of a transmission destination, which is determined as the transmission destination corresponding to the job data, to print the drawing data of the higher image format under the print setting specified by the job information data so as to generate output data containing raster data compatible with a printer of the transmission destination.

2. The data processing apparatus according to claim 1, wherein
the virtual printer driver unit has
a virtual print management unit that receives the job data and stores image data to be moved into the work space in a job storage unit,
a data extraction unit that is invoked by the virtual print management unit and separates and extracts the job information data from the job data, and
a virtual drawing unit that is invoked by the virtual print management unit, generates the work space corresponding to the job, and generates the drawing data of the higher image format in the work space.

3. The data processing apparatus according to claim 1, wherein
the transmission processing unit has
a transmission destination control unit that determines the transmission destination of the output data from the job information data extracted from the job data; and
a data transmission unit that transmits the drawing data inside the work space to the printer driver corresponding to the transmission destination determined by the transmission destination control unit.

4. The data processing apparatus according to claim 1, further comprising
a process ID table unit that manages a process ID and the transmission destination of the output data corresponding to the job data in association with each other so as to inherently identify the job data, wherein
the drawing data inside the work space are transmitted to the transmission destination determined in such a manner that the transmission processing unit identifies the printer driver for the corresponding job data, thereby generating RAW data inherent in the printer of the transmission destination.

5. The data processing apparatus according to claim 1, wherein
the drawing data are of a format including a drawing code.

6. The data processing apparatus according to claim 5, wherein
the higher image format including the drawing code is an EMF, a PostScript, a PDF, or an XPS.

7. The data processing apparatus according to claim 2, wherein
the application execution unit has
an application unit that generates the job data containing the image data, and
a print instruction unit that performs setting for print processing and instructs print execution, wherein
the application execution unit receives a print execution event of the job data containing the image data generated by the application unit and generates a process ID for inherently identifying the job data.

8. The data processing apparatus according to claim 2, wherein
the application execution unit executes processing in response to a request from a client computer connected through a network and generates the job data containing the image data.

9. The data processing apparatus according to claim 8, wherein
the client computer is a thin client, and the application execution unit is a terminal server that generates the job data by executing processing upon receiving the request from the thin client and transfers the job data to the remotely-connected data processing apparatus.

10. A computer-readable recording medium having recorded therein a computer-executable program that causes a computer to serve as a data processing apparatus that receives job data from an application execution unit and prints the same, the program causing the computer to serve as:
a virtual printer driver unit that is invoked upon receiving the job data from the application execution unit, extracts job information data specifying print setting from the job data, generates a work space to perform image conversion for each job, and generates drawing data of a higher image format from the job data in the work space; and
a transmission processing unit that is generated as a private instance corresponding to the job data and instructs a printer driver of a transmission destination, which is determined as the transmission destination corresponding to the job data, to print the drawing data of the higher image format under the print setting specified by the job information data so as to generate output data containing raster data compatible with a printer of the transmission destination.
